(19) United States
(12) Patent Application Publication
(10) Pub. No.: US 2019/0317713 A1
(43) Pub. Date: Oct. 17, 2019

(54) IMAGE PROCESSING SYSTEM, IMAGE PROCESSING APPARATUS, AND IMAGE PROCESSING METHOD

(71) Applicant: TOSHIBA TEC KABUSHIKI KAISHA, Tokyo (JP)

(72) Inventor: Tomonori IKUMI, Numazu Shizuoka (JP)

(21) Appl. No.: 16/351,898

(22) Filed: Mar. 13, 2019

(30) Foreign Application Priority Data
Apr. 12, 2018 (JP) 2018-076845

(51) Int. Cl. G06F 3/12

(52) U.S. Cl. CPC G06F 3/1286; G06F 3/1239; G06F 3/1205

(57) ABSTRACT

An image processing system includes a server and an image processing apparatus. The server is configured to transmit, over a network, print data including a first identification of the print data. The image processing apparatus is configured to receive the print data, obtain the first identification of the print data from the print data, and generate code symbol data indicating the first identification of the print data and a second identification of the image processing apparatus. The image processing apparatus is further configured to print, on a sheet, an image corresponding to the print data together with a code symbol corresponding to the code symbol data.

### CROSS-REFERENCE TO RELATED APPLICATION

This application is based upon and claims the benefit of priority from Japanese Patent Application No. 2018-076845, filed on Apr. 12, 2018, the entire contents of which are incorporated herein by reference.

### FIELD

Embodiments described herein relate generally to an image processing system, an image processing apparatus, and an image processing method.

### BACKGROUND

An image processing apparatus such as a copying machine, a multifunction peripheral (MFP), or the like is configured to print an image corresponding to data distributed from a server over a network. One type of such an image may include an advertisement image of advertisement transmitted from an advertisement distributor. It would be beneficial to the advertisement distributor if it is possible to track how a printed advertisement image is utilized. For that purpose, it would be desirable to construct a mechanism with which it is possible to easily recognize the image processing apparatuses that has printed the advertisement.

### DESCRIPTION OF THE DRAWINGS

FIG. 1 is a block diagram illustrating a configuration of an image processing system according to an embodiment.

FIG. 2 is a schematic diagram illustrating a data structure of an advertisement data record according to the embodiment.

FIG. 3 is a schematic diagram illustrating a data structure of an MFP data record according to the embodiment.

FIG. 4 is a block diagram illustrating a configuration of main components of a server according to the embodiment.

FIG. 5 is a schematic diagram illustrating a configuration of an advertisement management table according to the embodiment.

FIG. 6 is a block diagram illustrating a configuration of main components of an MFP according to the embodiment.

FIG. 7 is a schematic diagram illustrating main memory areas in a main memory of the MFP according to the embodiment.

FIG. 8 is a flowchart depicting a flow of advertisement distribution processing executed by a processor of the server by executing an advertisement distribution program according to the embodiment.

FIG. 9 is a flowchart depicting a flow of advertisement printing processing executed by a processor of the MFP by executing an advertisement printing program according to the embodiment.

FIG. 10 is a schematic diagram illustrating an example of a print medium on which an advertisement image is printed according to the embodiment.

FIG. 11 is a schematic diagram illustrating a data structure of an advertisement code according to the embodiment.

FIG. 12 is a flowchart depicting a flow of advertisement copying processing executed by the processor of the MFP by executing an advertisement copying program according to the embodiment.

FIG. 13 is a flowchart depicting a flow of advertisement analysis processing executed by the processor of the server by executing an advertisement analysis program according to the embodiment.

FIG. 14 is a schematic diagram illustrating a data structure of a plug-in position table of an MFP according to another embodiment.

FIG. 15 is a schematic diagram illustrating an example of a print medium on which an advertisement image is printed according to another embodiment.

### DETAILED DESCRIPTION

According to an embodiment, an image processing system includes a server and an image processing apparatus. The server is configured to transmit, over a network, print data including a first identification of the print data. The image processing apparatus is configured to receive the print data, obtain the first identification of the print data from the print data, and generate code symbol data indicating the first identification of the print data and a second identification of the image processing apparatus. The image processing apparatus is further configured to print, on a sheet, an image corresponding to the print data together with a code symbol corresponding to the code symbol data.

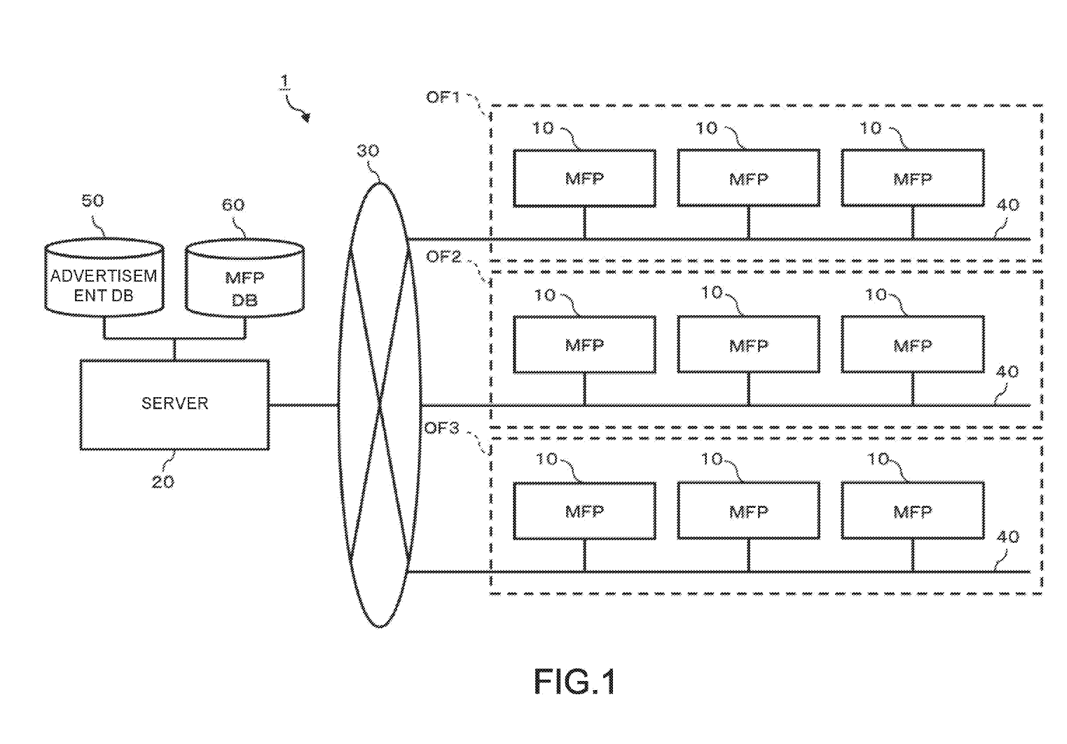

Hereinafter, an embodiment of an image processing system that enables for users to easily recognize an image processing apparatus that has printed a printed matter is described with reference to the accompanying drawings. First, a configuration of the image processing system is described with reference to FIG. 1 to FIG. 7.

FIG. 1 is a block diagram illustrating a configuration of an image processing system 1 according to an embodiment. The image processing system 1 includes a plurality of MFPs 10 installed in a plurality of offices OF1, OF2, and OF3, respectively, a server 20, and a network 30. The office is a company, a business office, a business site, etc. In FIG. 1, three offices are shown, but the number thereof is not limited to three. For example, the number of offices may be one or two, or four or more. The number of MFPs 10 arranged in the office is not limited to three. For example, in one office, the number of MFPs 10 may be one or two, or four or more.

The MFP 10 is an example of the image processing apparatus. The MFP 10 is a multifunctional peripheral having a printing function, a copying function, a facsimile function, a scanner function and the like, and is also referred to as a digital multifunction peripheral. The MFP 10 is connected to a LAN (Local Area Network) 40 in each of the offices OF1, OF2, and OF3. The LAN 40 is connected to a network 30 via a gateway device (not shown). The network 30 is, for example, the Internet.

The server 20 is managed, for example, by an advertisement distributor who collects advertisements from advertisers and transmits them to the respective offices OF1, OF2, and OF3. The server 20 includes an advertisement database 50 and an MFP database 60. The advertisement database 50 and the MFP database 60 may be stored in a storage device built in the server 20 or in a storage device externally attached to the server 20. Alternatively, the advertisement database 50 and the MFP database 60 may be stored in a storage device built in a computer different from the server 20, and the server accesses the advertisement database 50 and the MFP database 60 via the computer. In FIG. 1, the database is abbreviated as DB.

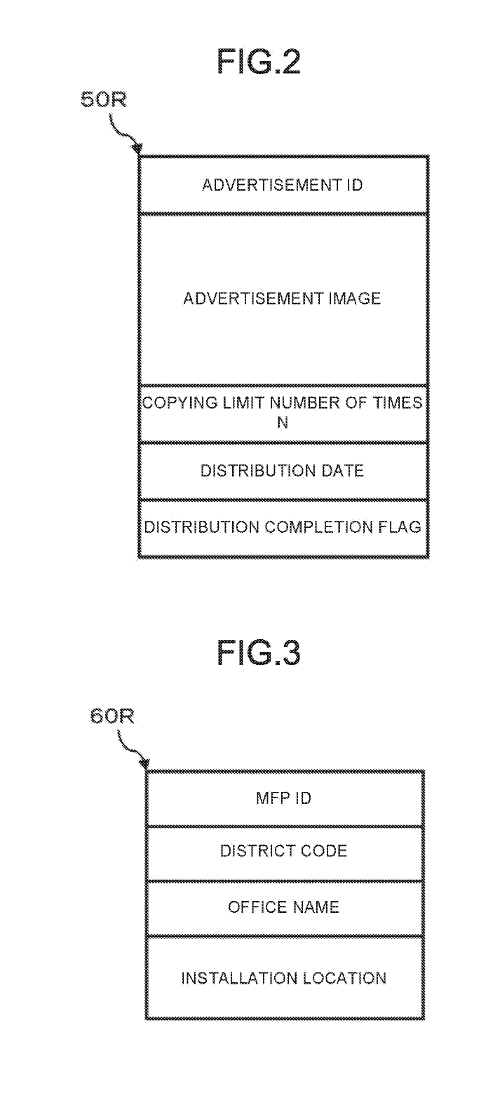

The advertisement database 50 stores a data record 50R (refer to FIG. 2) relating to an advertisement provided from an advertiser. FIG. 2 is a schematic diagram illustrating a data structure of the advertisement data record 50R. As shown in FIG. 2, the advertisement data record 50R includes items such as an advertisement ID, an advertisement image, a copying limit number of times N, a distribution date, a distribution completion flag, and the like. The advertisement data record 50R is created by the server 20 every time advertisement data is provided from the advertiser to the advertisement distributor, and is then written in the advertisement database 50.

The advertisement ID is uniquely set for each advertisement data record 50R for identification of the advertisement data record 50R. The advertisement image is image data of an advertisement to be printed by the MFP 10. A file format of the image data is not particularly limited. For example, the file format may be JPEG (Joint Photographic Group), PNG (Portable Network Graphics), GIF (Graphics Interchange Format), or the like. The image data may be text data. Here, the advertisement ID functions as first identification data for identifying the advertisement image, which is the print data.

The copying limit number of times N is a value for limiting the number of times the advertisement image is copied. For example, if the copying is permitted only once, “1” is recorded as the copying limit number of times N. For example, if the copy is permitted up to 5 times, “5” is recorded as the copying limit number of times N. If the copying is not permitted, “0” is recorded as the copying limit number of times N. For example, “X” is recorded as the copying limit number of times N if the copy is not limited.

The distribution date is a date when the advertisement image is distributed to the MFP 10. Any distribution date may be set, for example, by the advertiser together with the copying limit number of times N.

The distribution completion flag is 1-bit information for specifying whether or not an advertisement image has already been distributed. In the present embodiment, “1” is set in the distribution completion flag indicating that the advertisement image has already been distributed, and “0” is set in the distribution completion flag indicating that no advertisement image has been distributed.

The MFP database 60 stores a data record 60R (refer to FIG. 3) relating to the MFP 10 installed in each of the offices OF1, OF2, and OF3. FIG. 3 is a schematic diagram illustrating a data structure of the MFP data record 60R. As shown in FIG. 3, the MFP data record 60R includes an MFP ID, a district code, an office name, an installation location, and the like. Every time a new office accepts an advertisement distribution service from the advertisement distributor, the MFP data record 60R is created by the server 20 in accordance with the number of MFPs installed in the office, and is written in the MFP database 60.

The MFP ID is uniquely set for each MFP 10 to individually identify the MFP 10. The district code is set for a district of the office where the MFP 10 is installed. A common district code may be set for different districts. The district codes may be assigned, for example, according to cities, wards, towns, and/or villages.

The office name is used for identifying the office where the MFP 10 is installed. The installation location is used for specifying a location in the office where the MFP 10 is installed. For example, information such as “1st floor⋅sales headquarters”, “2nd floor⋅general affairs department” etc. is included in the data record 60R as the installation location of the MFP 10.

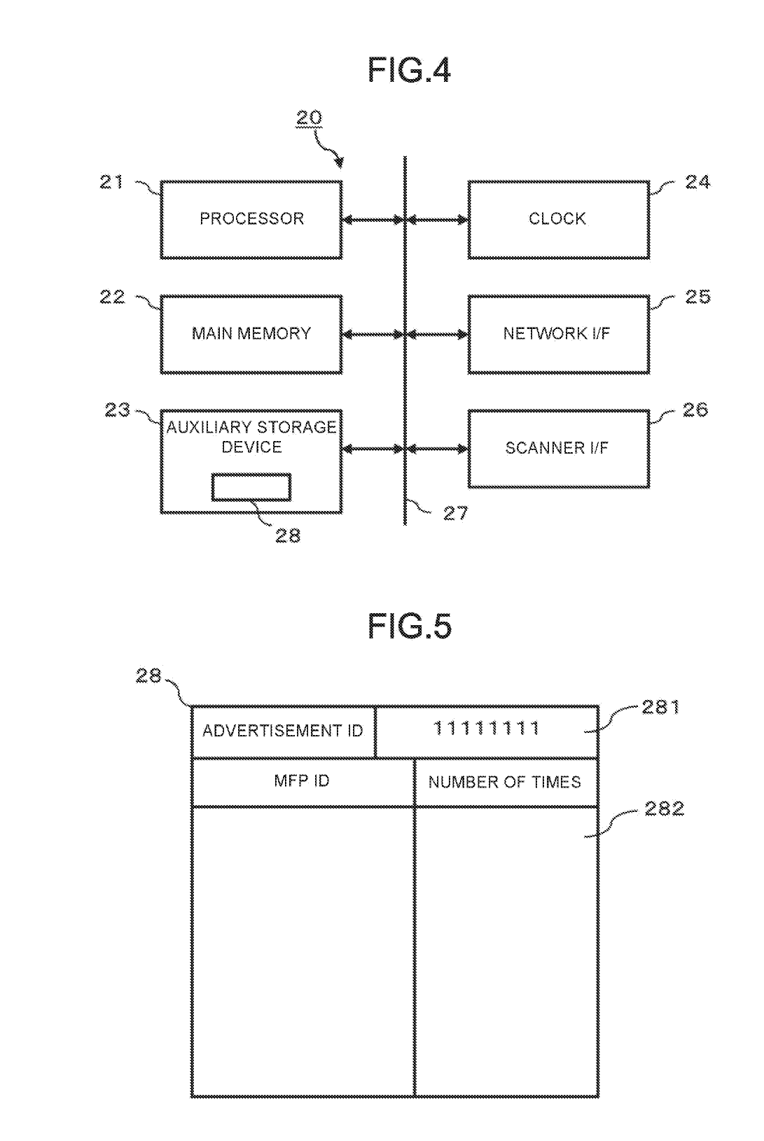

FIG. 4 is a block diagram illustrating a configuration of main portions of the server 20. The server 20 comprises a processor 21, a main memory 22, an auxiliary storage device 23, a clock 24, a network interface 25, a scanner interface 26, and a system transmission path 27. In FIG. 4, the interface is abbreviated as an I/F.

The system transmission path 27 includes an address bus, a data bus, a control signal line, and the like. In the server 20, the processor 21, the main memory 22, the auxiliary storage device 23, the clock 24, the network interface 25, and the scanner interface 26 are connected to the system transmission path 27. In the server 20, the processor 21, the main memory 22, the auxiliary storage device 23, and the system transmission path 27 connecting these components constitute a computer.

The processor 21 acts as a central component of the computer. The processor 21 controls each of the other components to perform various functions of the server 20 by executing an operating system and an application program. The processor 21 is, for example, a CPU (Central Processing Unit).

The main memory 22 acts as main storage of the computer. The main memory 22 includes a nonvolatile memory area and a volatile memory area. The main memory 22 stores the operating system and the application program in the nonvolatile memory area. The main memory 22 may store data necessary for the processor to control each component in the nonvolatile or volatile memory area in some cases. The main memory 22 uses the volatile memory area as a work area where the data is appropriately rewritten by the processor. For example, the nonvolatile memory area is a ROM (Read Only Memory). The volatile memory area is a RAM (Random Access Memory).

The auxiliary storage device 23 acts as auxiliary storage of the computer. For example, the auxiliary storage device 23 may be an EEPROM (Electric Erasable Programmable Read-Only Memory), an HDD (Hard Disk Drive), an SSD (Solid State Drive), or the like. The auxiliary storage device 23 stores data used by the processor 21 to perform various kinds of processing and data generated in the processing by the processor 21. The auxiliary storage device 23 may store the above-described application program in some cases.

The clock 24 functions as a time information source of the server 20. The processor 21 counts the current date and time based on time information counted by the clock 24. The network interface 25 is connected to the network 30. The network interface 25 transmits and receives data in conformity with a communication protocol with a plurality of MFPs 10 connected via the network 30. The scanner interface 26 connects to a scanner (not shown). The scanner is used for reading code symbols such as a barcode, a two-dimensional data code, and the like.

The server 20 can store an advertisement management table 28 in the auxiliary storage device 23. FIG. 5 is a schematic diagram illustrating a configuration of the advertisement management table 28. As shown in FIG. 5, the advertisement management table 28 includes an area 281 in which an advertisement ID is recorded and an area 282 in which the number of times of use is recorded for each MFP ID. The use of the advertisement management table 28 is described below.

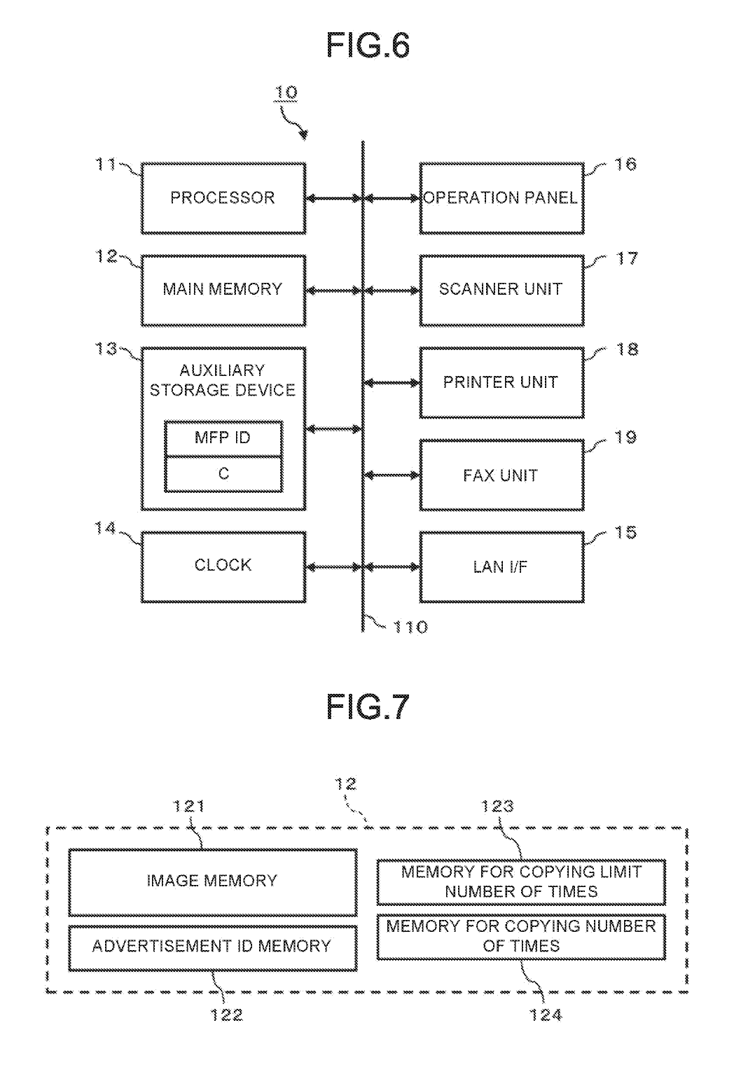

FIG. 6 is a block diagram illustrating a configuration of main components of the MFP 10. The MFP 10 includes a processor 11, a main memory 12, an auxiliary storage device 13, a clock 14, a LAN interface 15, an operation panel 16, a scanner unit 17, a printer unit 18, a facsimile unit 19, and a system transmission path 110. In FIG. 6, the facsimile is abbreviated as a FAX, and the interface is abbreviated as an I/F.

The system transmission path 110 includes an address bus, a data bus, a control signal line, and the like. In the MFP 10, the processor 11, the main memory 12, the auxiliary storage device 13, the clock 14, the LAN interface 15, the operation panel 16, the scanner unit 17, the printer unit 18, and the facsimile unit 19 are connected to the system transmission path 110. In the MFP 10, the processor 11, the main memory 12, the auxiliary storage device 13, and the system transmission path 110 connecting these components constitute a computer.

The processor 11 acts as a central component of the computer. The processor 11 controls each of the other components to perform various functions of the MFP 10 by executing an operating system and an application program. The processor 11 is, for example, a CPU.

The main memory 12 acts as main storage of the computer. The main memory 12 includes a nonvolatile memory area and a volatile memory area. The main memory 12 stores the operating system and the application program in the nonvolatile memory area. The main memory 12 may store data necessary for the processor to control each component in the nonvolatile or volatile memory area in some cases. The main memory 12 uses the volatile memory area as a work area where the data is appropriately rewritten by the processor. For example, the nonvolatile memory area is a ROM. The volatile memory area is a RAM.

The auxiliary storage device 13 acts as auxiliary storage of the computer. For example, the auxiliary storage device 13 may be an EEPROM, an HDD, an SSD, or the like. The auxiliary storage device 13 stores data used by the processor 11 to perform various kinds of processing and data generated in processing by the processor 11. The auxiliary storage device 13 may store the above-described application program in some cases.

The clock 14 functions as a time information source of the MFP 10. The processor 11 counts the current date and time based on time information counted by the clock 14.

The LAN interface 15 is connected to a LAN 40. The MFP 10 performs data communication with other devices including the server 20 via the LAN 40.

The operation panel 16 includes a display, which is a display device, and a keyboard, which is an input device. The display is a touch-panel-type display in which a touch sensor which is also the input device is superimposed on a surface of a screen of the display. The keyboard is provided with a plurality of keys necessary for the MFP 10 such as a numeric keypad, a start key, a reset key, and the like. A mode key for switching an operation mode of the MFP 10 is also arranged on the keyboard. The operation modes of the MFP 10 include a printing mode, a copying mode, a facsimile mode, and the like. The MFP 10 of the present embodiment includes an advertisement copying mode used in a case of copying a printed matter, which may be an advertisement image, and the advertisement copying mode is different from a normal copying mode in which a normal printed matter is copied.

The scanner unit 17 includes a lamp, a mirror, a CCD (Charge Coupled Device) or the like as a photoelectric conversion element, and the like. The lamp irradiates a document placed on a document table with light. The mirror deflects the reflected light from the document. The CCD receives an optical image from the mirror and performs photoelectric conversion. The scanner unit 17 reads a document image on the document table by moving in a sub-scanning direction with respect to the document placed on the document table. The read optical image is photoelectrically converted by the CCD, and is then output to the processor 11 as print data after predetermined processing.

The printer unit 18 forms an image in, for example, an electrophotographic manner. Specifically, the printer unit 18 exposes a photoconductor with a light beam emitted from a laser light source that is controlled to light based on print data processed for image formation to generate an electrostatic latent image. The printer unit 18 develops the generated electrostatic latent image with toner and then transfers the formed toner image onto a sheet which is a print medium. The printer unit 18 fixes the toner image to the sheet by enabling the sheet onto which the toner image has been transferred to pass through a fixing section heated by a fixing heater therein. If post-processing is instructed, the printer unit 18 performs printout through the processing.

If the facsimile image data is received via the LAN 40, the facsimile unit 19 generates print image data from the facsimile image data and outputs the print image data to the printer unit 18. The facsimile unit 19 transmits the facsimile image data formed by the MFP 10 to a destination device via the LAN 40.

The MFP 10 stores the MFP ID and a number of times of advertisement printing C in the auxiliary storage device 13. The MFP ID functions as the second identification data unique to the MFP 10. The number of times of advertisement printing C is a total number of advertisement images printed by the MFP 10. By counting the number of times the advertisement image has been printed, it is possible to manage a charge for advertisement printing. Specifically, in the case of normal printing, a user of the MFP 10 typically bears a printing cost, but in the case of advertisement printing, the user may not bear the printing cost. The printing cost is borne, for example, by an advertisement distributor.

As shown in FIG. 7, in the MFP 10, a volatile area 120 of the main memory 12 includes an image memory 121, an advertisement ID memory 122, a memory for copying limit number of times 123, and a memory for copying number of times 124. The use of these areas is described below.

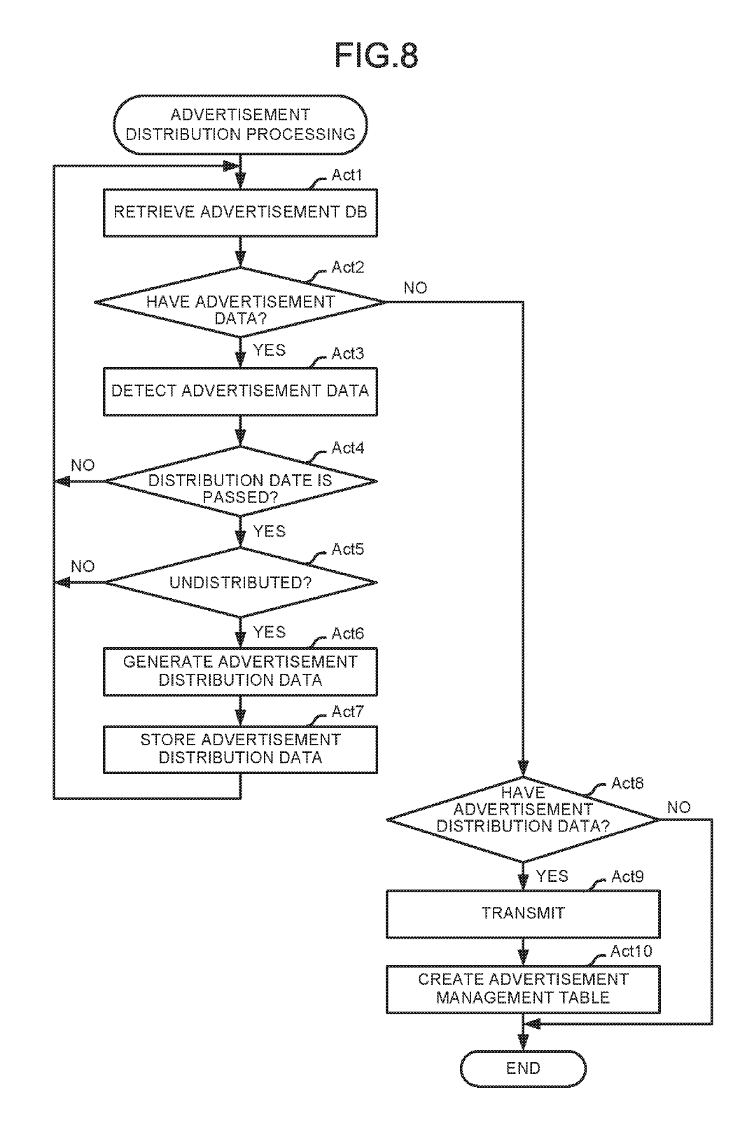

Next, a main operation of the image processing system 1 is described with reference to FIG. 8 to FIG. 13.

FIG. 8 is a flowchart depicting a flow of advertisement distribution processing executed by the processor 21 of the server 20 by executing an advertisement distribution program. The advertisement distribution program is stored in the main memory 22 or the auxiliary storage device 23. The content of the processing described below is merely an example. As long as the same result can be achieved, the processing procedure and the processing content are not particularly limited.

Execution of the advertisement distribution program is started when the time counted by the clock 24 reaches a preset time. If execution of the advertisement distribution program is started, the processor 21 starts the processing shown in the flowchart in FIG. 8. In Act 1, the processor 21 retrieves the advertisement database 50. In Act 2, the processor 21 determines whether or not there is an unprocessed advertisement data record 50R in the advertisement database 50. If there is an unprocessed advertisement data record 50R, the processor 21 determines Yes in Act 2 and the process proceeds to Act 3. In Act 3, the processor 21 retrieves the unprocessed advertisement data record 50R from the advertisement database 50.

In Act 4, the processor 21 determines whether or not a distribution date has passed from the distribution date of the advertisement data record 50R and the date counted by the clock 24. If the distribution date has not passed yet, the processor 21 determines No in Act 4 and the process returns to Act 1.

If the distribution date has passed in Act 4, the processor 21 determines Yes and the process proceeds to Act 5. In Act 5, the processor 21 determines whether or not the advertisement data record 50R is undistributed by checking the distribution completion flag of the advertisement data record 50R. When the distribution completion flag is “1”, i.e., when the advertisement data record 50R read from the advertisement database 50 has already been distributed, the processor 21 determines No in Act 5 and the process returns to Act 1.

In Act 5, when the distribution completion flag is “0”, i.e., when the advertisement data record 50R read from the advertisement database 50 is undistributed, the processor 21 determines Yes and the process proceeds to in Act 6. In Act 6, the processor 21 generates the advertisement distribution data. The advertisement distribution data includes the advertisement ID, the advertisement image, and the copying limit number of times N contained in the advertisement data record 50R. The advertisement distribution data also includes, for example, information indicating that the data is the advertisement distribution data as a header of the data record. In Act 7, the processor 21 temporarily stores the advertisement distribution data in a transmission buffer held in the volatile area of the main memory 22. If Act 6 and Act 7 are finished, the process returns to Act 1.

After returning to Act 1, the processor 21 retrieves the advertisement database 50 again. The processor 21 repeats the processing in Act 3 to Act 7 in the same way as described above until there is no unprocessed advertisement data record 50R in the advertisement database 50. In other words, the processor 21 retrieves, from the advertisement database 50, the undistributed advertisement data record 50R of which distribution date has passed. The processor 21 generates the advertisement distribution data based on the advertisement data record 50R and stores the advertisement distribution data in the transmission buffer.

If the processor 21 determines that there is no unprocessed advertisement data record 50R in the advertisement database 50, the processor 21 determines No in Act 2 and the process proceeds to Act 8. In Act 8, the processor 21 determines whether or not the advertisement distribution data is stored in the transmission buffer. If the advertisement distribution data is not stored in the transmission buffer, the processor 21 determines No in Act 8 and terminates the advertisement distribution processing.

On the other hand, in Act 8, if the advertisement distribution data is stored in the transmission buffer, the processor 21 determines Yes and the process proceeds to Act 9. In Act 9, the processor 21 controls the network interface 25 to transmit the advertisement distribution data stored in the transmission buffer to the network 30. The network interface 25 transmits the advertisement distribution data acquired from the transmission buffer to the network 30. If a plurality of the advertisement distribution data is stored in the transmission buffer, the network interface 25 acquires the advertisement distribution data one by one and then transmits the advertisement distribution data to the network 30.

As described above, the processor 21 cooperates with the network interface 25 to transmit the advertisement distribution data, which is the print data, to the network 30, together with the advertisement ID, which is the first identification data for identifying the print data, and the copying limit number of times N.

In Act 10, the processor 21 controlling the transmission of the advertisement distribution data creates an advertisement management table 28 for each of the advertisement distribution data. The created advertisement management table 28 is stored in the auxiliary storage device 23. In the advertisement management table 28 stored in the auxiliary storage device 23, an advertisement ID included in the advertisement distribution data is recorded in the area 281. The area 282 is blank. Then, the processor 21 terminates the advertisement distribution processing.

The advertisement distribution data transmitted to the network 30 is distributed to the MFP 10 in each of the offices OF1, OF2, and OF3 via the LAN 40.

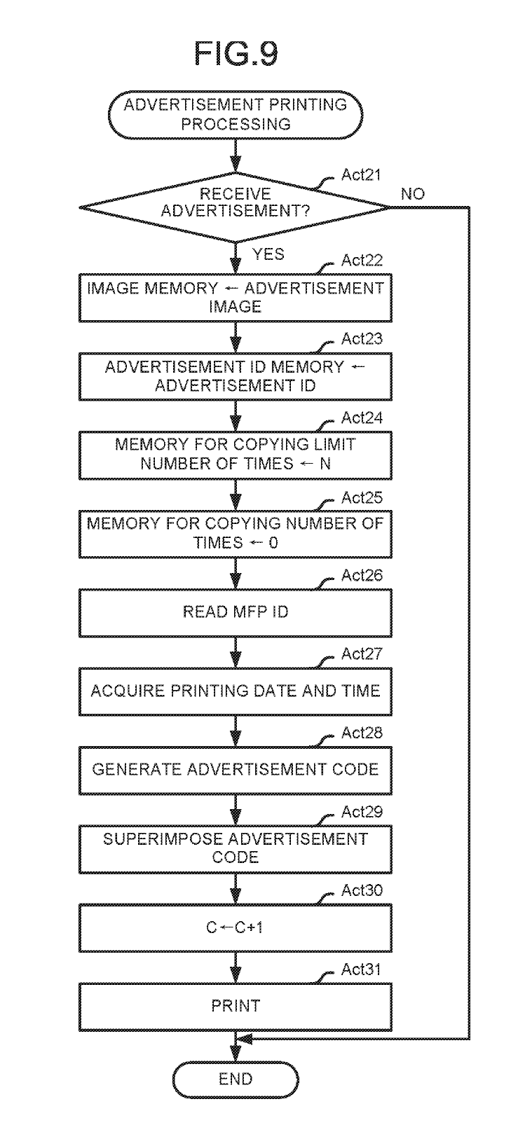

Upon receiving the advertisement distribution data, the processor 11 of the MFP 10 executes the advertisement printing processing shown in the flowchart in FIG. 9. FIG. 9 is a flowchart depicting a flow of advertisement printing processing executed by the processor 11 by executing an advertisement printing program. The advertisement printing program is one of the application programs included in the MFP 10. The advertisement printing program is stored in the main memory 12 or the auxiliary storage device 13. The content of the processing described below is merely an example. As long as the same result can be achieved, the processing procedure and the processing content are not particularly limited.

Execution of the advertisement printing program is started if the print data is received via the LAN interface 15 functioning as a reception section. If execution of the advertisement printing program is started, the processor 11 determines whether or not the print data is the advertisement distribution data in Act 21. As described above, for example, the advertisement distribution data includes, as the header, information indicating that the data is the advertisement distribution data. The processor 11 determines whether or not the print data is the advertisement distribution data based on whether the information indicating that the data is the advertisement distribution data is included in the header of the print data. If the print data is not the advertisement distribution data, the processor 11 determines No in Act 21 and terminates the advertisement printing processing.

If the print data is the advertisement distribution data, the processor 11 determines Yes in Act 21 and the process proceeds to Act 22. In Act 22, the processor 11 acquires an advertisement image from the advertisement distribution data and writes the advertisement image in the image memory 121. In Act 23, the processor 11 acquires the advertisement ID from the advertisement distribution data and writes the advertisement ID in the advertisement ID memory 122. In Act 24, the processor 11 acquires the copying limit number of times N from the advertisement distribution data and writes the copying limit number of times in the memory for copying limit number of times 123. In Act 25, the processor 11 sets a value of the memory for copying number of times 124 to “0”. In Act 26, the processor 11 reads the MFP ID stored in the auxiliary storage device 13. In Act 27, the processor 11 acquires the date and time counted by the clock 14 as a printing date and time.

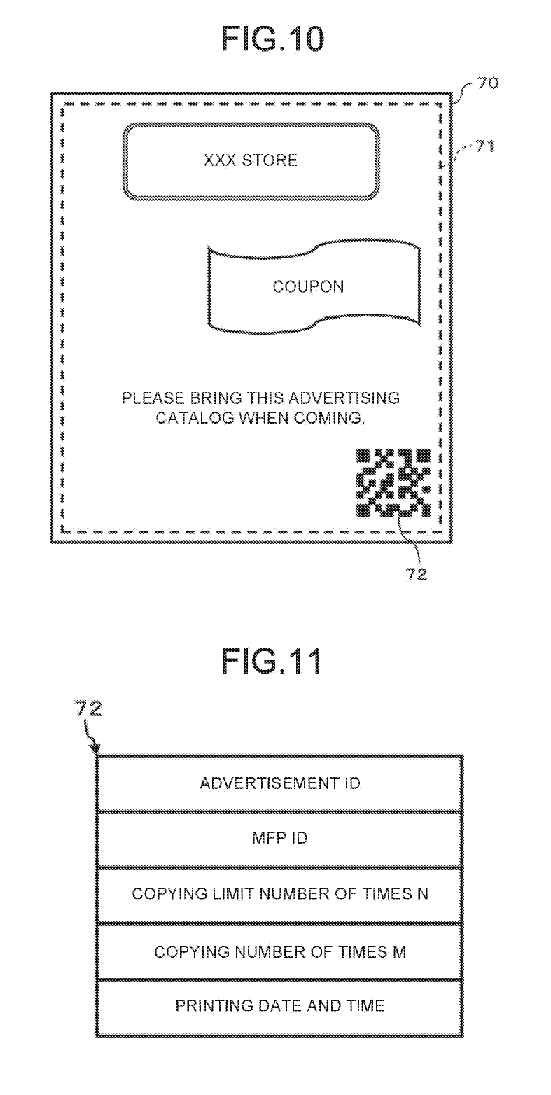

The processing procedures in Act 22 to Act 27 described above are not limited thereto. The order of the processing procedures may be changed as appropriate. If the processing in Act 22 to Act 27 is finished, the processor 11 generates an advertisement code 72 in Act 28. The advertisement code 72 is generated in a symbol form of a two-dimensional data code as shown in FIG. 10.

FIG. 11 is a schematic diagram illustrating a data structure of the advertisement code 72. As shown in FIG. 11, the advertisement code 72 includes an advertisement ID, an MFP ID, a copying limit number of times N, a copying number of times M, and a printing date and time. The advertisement ID is recorded in the advertisement ID memory 122. The MFP ID is read from the auxiliary storage device 13. The copying limit number of times N is recorded in the memory for copying limit number of times 123. The copying number of times M is recorded in the memory for copying number of times 124. The printing date and time is acquired from the clock 14.

Returning again to FIG. 9, in Act 29, the processor 11 superimposes an image of the advertisement code 72 generated in Act 28, i.e., the two-dimensional data code, at a pre-designated position of the advertisement image stored in the image memory 121. In Act 30, the processor 11 increases the number of times of advertisement printing C stored in the auxiliary storage device 13 by “1”. In Act 31, the processor 11 controls the printer unit 18 to print the advertisement image superimposed with the advertisement code 72 on the print medium.

Here, the processor 11 serves as a generation module by executing the processing in Act 22 to Act 28. The processor serves as an image forming module by executing the processing in Act 29. The processor 11 cooperates with the printer unit 18 to execute the processing in Act 31 to serve as a printing module. The processor 11 functions as a controller including the generation module, the image forming module, and the printing module.

FIG. 10 is a schematic diagram illustrating an example of a print medium 70 on which an advertisement image 71 is printed. As shown in FIG. 10, a two-dimensional data code indicating the advertisement code 72 is printed on the print medium 70, together with the advertisement image 71. For example, the advertisement code 72 is superimposed at a lower right portion as the pre-designated position of the advertisement image 71.

As described above, in the image processing system 1 according to the present embodiment, the server 20 generates the advertisement distribution data based on the advertisement data record 50R registered in the advertisement database 50, and transmits the advertisement distribution data via the network 30 to the MFP 10 in each of the offices OF1, OF2, and OF3.

The MFP 10 receiving the advertisement distribution data generates the advertisement code 72 including the advertisement ID included in the advertisement distribution data and the MFP ID unique to the MFP 10. In the MFP 10, the advertisement code 72 is superimposed at a pre-designated position of the advertisement image 71 included in the advertisement distribution data. The MFP 10 prints the advertisement image 71 superimposed with the advertisement code 72 on the print medium 70 with the printer unit 18.

As a result, the advertisement distributor can easily recognize the MFP 10 that has printed the advertisement image 71 by analyzing the advertisement code 72 printed together with the advertisement image 71 on the print medium 70.

The advertisement code 72 also includes information relating to the printing date and time. Therefore, by analyzing the advertisement code 72, the advertisement distributor can also easily recognize the date and time at which the advertisement image 71 has been printed.

The advertisement code 72 includes the copying limit number of times N and the copying number of times M. The copying limit number of times N and the copying number of times M are used when the advertisement image 71 is copied in the MFP 10.

As shown in FIG. 10, it is assumed that an image that can be used as a coupon is used as the advertisement image 71. Specifically, employees of the offices OF1, OF2, and OF3 brings the print medium 70 on which the advertisement image 71 is printed to a target store to enjoy a privilege such as price discount or the like. In this case, the advertiser allows an employee to copy the advertisement image 71 on another print medium using the copying function of the MFP 10. By doing so, the same advantage as distribution of the advertisement images 71, the number of which is equal to or greater than the number of the MFPs 10, to the offices OF1, OF2, and OF3 can be achieved. However, if the copying without limit is permitted, it may impair the benefit of the store. Therefore, the advertiser sets the copying limit number of times N when providing the advertisement data. The MFP 10 disables the copying of the advertisement image 71 when the number of times the advertisement image 71 is copied exceeds the copying limit number of times N. The function is enabled when the MFP 10 is in the advertisement copying mode.

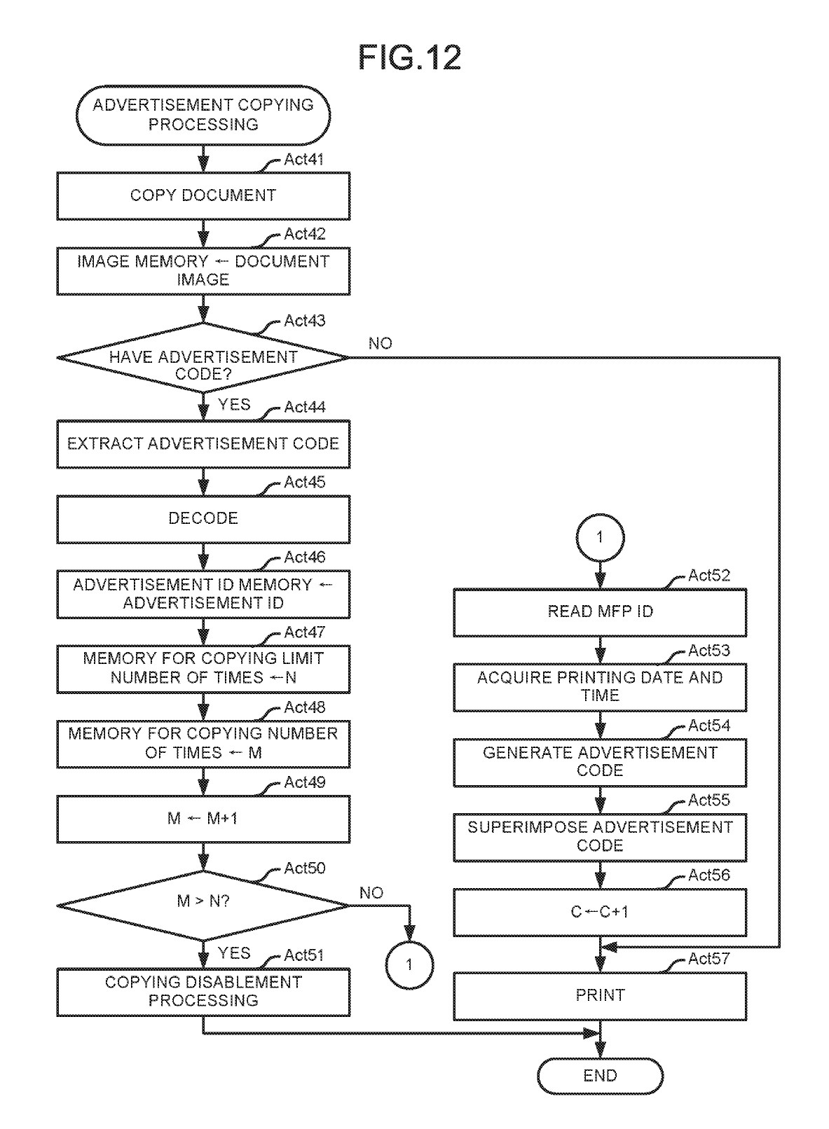

FIG. 12 is a flowchart depicting a flow of advertisement copying processing executed by the processor 11 of the MFP 10 by executing the advertisement copying program. The advertisement copying program is one of the application programs included in the MFP 10. The advertisement copying program is stored in the main memory 12 or the auxiliary storage device 13. The content of the processing described below is merely an example. As long as the same result can be achieved, the processing procedure and the processing content are not particularly limited.

Execution of the advertisement copying program is started when the advertisement copying mode is selected as an operation mode of the MFP 10 by an operation input to the operation panel 16. If execution of the advertisement copying program is started, the processor 11 controls the scanner unit 17 to read the document image placed on the document table in Act 41. In Act 42, the processor 11 writes the document image read by the scanner unit 17 in the image memory 121.

In Act 43, the processor 11 determines whether or not the image of the advertisement code 72 is included in the document image written in the image memory 121. If the image of the advertisement code 72, i.e., the two-dimensional data code is not included, the processor 11 determines No in Act 43, and the process proceeds to Act 57. In Act 57, the processor 11 controls the printer unit 18 to print the document image written in the image memory 121 on the print medium. Even in the advertisement copying mode, the MFP 10 can copy the document image other than the advertisement image.

If the image of the advertisement code 72, i.e., the two-dimensional data code is included in the document image, the processor 11 determines Yes in Act 43 and the process proceeds to Act 44. In Act 44, the processor 11 extracts the advertisement code 72 from the document image. In Act 45, the processor 11 decodes the advertisement code 72. In Act 46, the processor 11 records the advertisement ID obtained by decoding the advertisement code 72 in the advertisement ID memory 122. In Act 47, the processor 11 records the copying limit number of times N obtained by decoding the advertisement code 72 in the memory for copying limit number of times 123. In Act 48, the processor 11 records the copying number of times M obtained by decoding the advertisement code 72 in the memory for copying number of times 124.

The processing procedure in Act 46 to Act 48 described above is not limited thereto. The order of the processing procedures may be changed as appropriate. If the processing of Act 46 to Act 48 is finished, the processor 11 rewrites the copying number of times M recorded in the memory for copying number of times 124 with a value obtained by adding “1” thereto in Act 49. In Act 50, the processor 11 compares the copying limit number of times N recorded in the memory for copying limit number of times 123 with the copying number of times M recorded in the memory for copying number of times 124, and determines whether or not the copying number of times M exceeds the copying limit number of times N.

If the copying number of times M exceeds the copying limit number of times N, the processor 11 determines Yes in Act 50 and the process proceeds to Act 51. In Act 51, the processor 11 executes a copying disablement processing. For example, the processor 11 displays a guidance for informing an operator that the copying of the advertisement image is disabled on a display of the operation panel 16, and clears the image memory 121, the advertisement ID memory 122, the memory for copying limit number of times 123, and the memory for copying number of times 124. If the copying disablement processing is terminated, the processor 11 terminates the advertisement copying processing.

If the copying number of times M does not exceed the copying limit number of times N, the processor 11 determines No in Act 50 and the process proceeds to Act 52. The processor 11 executes the same processing as in Act 26 to Act 31 of the advertisement printing processing in Act 52 to Act 57. Specifically, in Act 52, the processor 11 reads the MFP ID from the auxiliary storage device 13. In Act 53, the processor 11 acquires the printing date and time from the clock 14. In Act 54, the processor 11 generates the advertisement code 72. In Act 55, the processor 11 superimposes the image of the advertisement code 72, i.e., the two-dimensional data code at a pre-designated position of the advertisement image stored in the image memory 121. In Act 56, the processor 11 increases the number of times of advertisement printing C by “1”. In Act 57, the processor 11 controls the printer unit 18 to print the advertisement image superimposed with the advertisement code 72 on the print medium.

Here, the processor 11 serves as a second generation module by executing the processing in Act 44 to Act 49 and Act 52 to Act 54. The processor 11 serves as a comparison module by executing the processing in Act 50. The processor 11 serves as a copied image forming module by executing the processing in Act 55.

As described above, in the image processing system 1 according to the present embodiment, if the MFP 10 reads the advertisement image 71 printed on the print medium 70 with the scanner unit 17, the MFP 10 extracts the advertisement code 72 from the advertisement image 71. The MFP 10 decodes the advertisement code 72 to acquire the advertisement ID, the copying limit number of times N, and the copying number of times M. The MFP 10 increases the copying number of times M by “1”.

The MFP 10 determines whether or not the copying number of times M exceeds the copying limit number of times N. If the copying number of times M does not exceed the copying limit number of times N, the MFP 10 regenerates the advertisement code 72. The advertisement code 72 before regeneration is indicated as an advertisement code 72-1, and the regenerated advertisement code is indicated as an advertisement code 72-2. The advertisement code 72-2 is obtained by increasing the copying number of times M of the advertisement code 72-1 by “1”. In the advertisement code 72-2, the printing date is also updated with respect to the advertisement code 72-1. If the advertisement image 71 superimposed with the advertisement code 72-1 is copied by an MFP 10 which is different from the MFP 10 that has printed the advertisement image 71, the MFP ID of the advertisement code 72-2 is also changed with respect to the advertisement code 72-1.

The MFP 10 superimposes the regenerated advertisement code 72-2 at a pre-designated position of the advertisement image 71 read by the scanner unit 17. The MFP 10 prints the advertisement image 71 superimposed with the advertisement code 72-2 on the print medium 70 with the printer unit 18. By copying the advertisement image 71 superimposed with the advertisement code 72-2 by the MFP 10, the advertisement image 71 in which the advertisement code 72 is replaced with the advertisement code 72-2 from the advertisement code 72-1 is printed.

On the other hand, when the copying number of times M exceeds the copying limit number of times N, the MFP 10 executes the copying disablement processing. The copying of the advertisement image 71 is prohibited.

Therefore, the user of the MFP 10 (for example, the employees worked in the offices OF1, OF2, and OF3) can copy the advertisement image 71 distributed from the advertisement distributor a number of times within the copying limit number of times N distributed together with the advertisement image 71.

The advertisement code 72-2 is also printed with the advertisement image 71 copied by the MFP 10 in a superimposed manner. The copying number of times of the advertisement code 72-2 printed on the copied advertisement image 71 in a superimposed manner is “1” or more. Therefore, for example, the advertisement distributor can analyze the advertisement code 72-2 printed together with the advertisement image 71 on the print medium 70, and if the copying number of times M is “1” or more, the advertisement distributor can easily recognize that the advertisement image 71 has been copied by the MFP 10. The advertisement distributor can also easily recognize the number of copies from the copying number of times M.

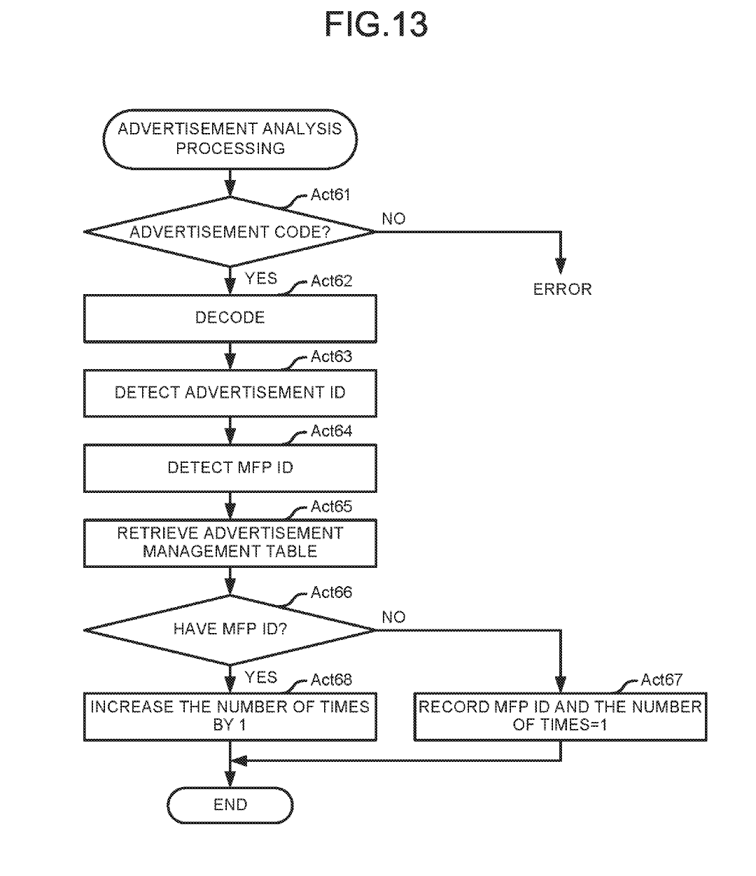

In order to recognize the MFP 10 that has printed or copied the advertisement image 71 for the advertisement distributor, it is necessary to analyze the advertisement code 72. The analysis of the advertisement code 72 is performed by the server 20. Next, an analysis operation executed by the server 20 is described with reference to FIG. 13.

FIG. 13 is a flowchart depicting a flow of advertisement analysis processing executed by the processor 21 of the server 20 by executing an advertisement analysis program. The advertisement analysis program is one of the application programs included in the server 20. The advertisement analysis program is stored in the main memory 22 or the auxiliary storage device 23. The content of the processing described below is merely an example. As long as the same result can be achieved, the processing procedure and the processing content are not particularly limited.

Execution of the advertisement analysis program is started if the two-dimensional data code is read by a scanner connected to the scanner interface 26. If execution of the advertisement analysis program is started, the processor 21 determines whether or not the two-dimensional data code is the advertisement code 72 in Act 61. If a two-dimensional data code other than the advertisement code 72 is read, the processor 21 determines No in Act 61 and sets it as an error.

If the two-dimensional data code which is the advertisement code 72 is read, the processor 21 determines Yes in Act 61 and the process proceeds to Act 62. In Act 62, the processor 21 decodes the advertisement code 72. In Act 63, the processor 21 detects the advertisement ID obtained by decoding the advertisement code 72. In Act 64, the processor 21 detects the MFP ID obtained by decoding the advertisement code 72.

The processing procedures in Act 63 and Act 64 described above are not limited thereto. The order of the processing procedures may be changed. If Act 63 and Act 64 are finished, in Act 65, the processor 21 searches the auxiliary storage device 23 for the advertisement management table 28 in which the advertisement ID recorded in the area 281 is coincident with the advertisement ID detected by the processing in Act 63. If the advertisement management table 28 can be detected, the processor 21 determines whether or not the MFP ID detected by the processing in Act 64 is recorded in the area 282 of the advertisement management table 28 in Act 66.

If the MFP ID detected by the processing in Act 64 is not recorded in the area 282 of the advertisement management table 28, the processor 21 determines No in Act 66 and the process proceeds to Act 67. In Act 67, the processor 21 stores the MFP ID detected by the processing in Act 64 and the data indicating that the number of times is “1” in the area 282 of the advertisement management table 28 in an associated manner.

If the MFP ID detected by the processing in Act 64 is recorded in the area 282 of the advertisement management table 28, the processor 21 determines Yes in Act 66 and the process proceeds to Act 68. In Act 68, the processor 21 rewrites the data indicating the number of times recorded in the area 282 in association with the MFP ID detected by the processing in Act 64 with a value obtained by increasing the above number of times by “1”. Then, the processor 21 terminates the advertisement analysis processing.

In this way, the server 20 generates the advertisement management table 28 for each advertisement ID of the advertisement image 71 distributed to the MFP 10. The server 20 obtains the advertisement ID and the MFP ID from the advertisement code 72 each time the scanner reads the advertisement code 72 printed together with the advertisement image 71. The server 20 records the number of times that the MFP ID has been detected in association with the detected MFP ID in the advertisement management table 28 in which the detected advertisement ID is set.

By referring to the data in the advertisement management table 28, the advertisement distributor can recognize the MFP 10 by which the advertisement image printed or copied is frequently used for each advertisement image. As a result, the advertisement distributor can easily verify the advertising effect with the MFP 10 which is a distribution destination of the advertisement image as a unit.

As described above in detail, according to the present embodiment, it is possible to provide the image processing system 1 with which the advertisement distributor can easily recognize the MFP 10 that has printed the print medium 70 of the advertisement image 71.

By recognizing the MFP 10 that has printed out the advertisement, it is possible to easily recognize which MFP 10 can lead to more effective marketing result. As a result, it can be determined that the distribution to the MFP 10 with a smaller marketing effect is terminated, and expenses on ineffective the advertisement distribution can be saved. Furthermore, a user of the MFP 10 is less likely to encounter unneeded advertisement, and the user does not need to do any to stop distribution of the advertisement.

According to the present embodiment, the print medium 70 of the advertisement image 71 can be copied by the MFP 10 a number of times within the copying limit number of times set for each advertisement image 71. When the advertisement image 71 is copied, it is possible to provide the image processing system 1 that enables to easily recognize the MFP 10 by which the advertisement image 71 has been copied.

According to the present embodiment, it is possible to provide the image processing system 1 that enables to easily recognize the MFP 10 by which the print medium 70 of the advertisement image 71 has been printed.

According to the present embodiment, it is possible to provide the MFP 10 that can copy the advertisement image 71 printed on the print medium 70 and can easily recognize the copying number of times M.

According to the present embodiment, it is possible to provide the MFP 10 that can copy the print medium 70 of the advertisement image 71 a number of times within the copying limit number of times set for each advertisement image 71. When the advertisement image 71 is copied, it is possible to easily recognize the MFP 10 by which the advertisement image 71 has been copied.

The embodiment above describes the image processing system that enables to recognize the image processing apparatus that has printed the printed matter; however, the embodiment of the present disclosure is not limited thereto.

In the above embodiment, the image printed on the printed matter is the advertisement image 71; however, the image is not limited to the advertisement image 71. For example, it may be an image of a pamphlet, an admission ticket, or the like to be distributed to an unspecified large number of users.

In the above embodiment, the MFP 10 is described as an example of the image processing apparatus, but the image processing apparatus may be a printing apparatus with only the printing function, such as a copying machine.

If a printing apparatus capable of performing a color printing and a printing apparatus capable of performing monochrome printing are mixed, the server 20 may select a transmission destination of advertisement distribution data depending on whether the advertisement image included in the advertisement data record 50R is a color image or a monochrome image. Alternatively, it may be set that the printing apparatus capable of performing the color printing receives the advertisement distribution data of a color image and the printing apparatus capable of performing the monochrome printing receives the advertisement distribution data of a monochrome image.

In the above embodiment, a case of printing the regenerated advertisement code 72-2 when copying the advertisement image 71 in place of the original advertisement code 72-1 is described. As another embodiment, the regenerated advertisement code 72-2 may be inserted at a different position from the original advertisement code 72-1.

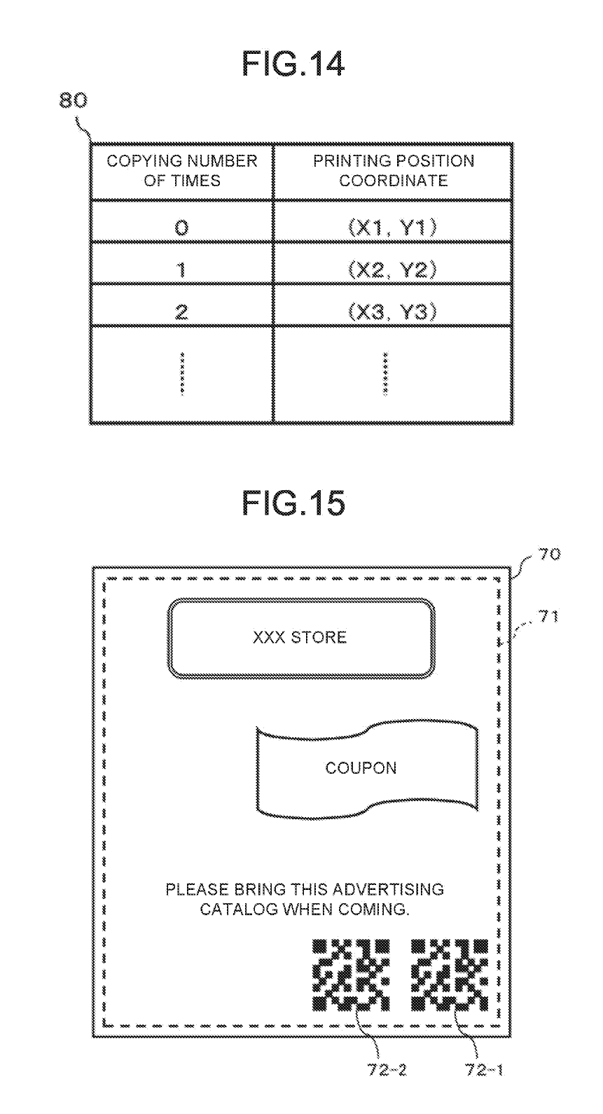

In this case, as shown in FIG. 14, each MFP 10 maintains an insertion position table 80 in which a print position coordinate including X-Y two-dimensional coordinates are set in association with the copying number of times. The insertion position table 80 is stored in the auxiliary storage device 13, for example.

When superimposing the advertisement code 72-1 on the advertisement image 71 in Act 29 in FIG. 9, the processor 11 refers to the insertion position table 80 to position the advertisement code 72-1 with the print position coordinate corresponding to the copying number of times “0” as a base point. When superimposing the advertisement code 72-2 on the advertisement image 71 in Act 55 in FIG. 12, the processor 11 refers to the insertion position table 80 to position the advertisement code 72-2 with the print position coordinate corresponding to the copying number of times of the advertisement code as a base point.

By doing so, as shown in FIG. 15, each time the advertisement image 71 is copied, the advertisement image 71 to which the advertisement codes 72-1 and 72-2 are added is printed on the print medium 70.

In the above embodiment, the copying limit number of times N is set for each advertisement image 71. The copying limit number of times N may be a constant value irrespective of the advertisement image 71. Alternatively, the copying limit number of times N may be omitted. If the copying limit number of times N is omitted, the copying number of times is not restricted. However, since the advertisement code 72 includes the copying number of times M, by analyzing the advertisement code 72, it is possible to acquire the information indicating how many times the image has been copied. As the copying number of times increases, it can be recognized that the advertisement effect is high.

The copying limit number of times N and the copying number of times M may not be the values indicating the number of times. They may be any data corresponding to the number of times as long as the processor 11 of the MFP 10 can recognize it as the number of times.

In the above embodiment, it is described that execution of the advertisement analysis program is started when the two-dimensional data code is read by the scanner connected to the scanner interface 26. The advertisement analysis program may be started in response to reception of the read data of the two-dimensional data code from a terminal provided with the scanner which is connected via the network 30. By doing this, for example, a store clerk in a store who collects the print medium 70 from the customer uses the scanner to read the advertisement code 72 printed together with the advertisement image 71 on the print medium 70, and in this way, the analysis operation of the server 20 can be performed.

The access of the image processing apparatus is generally performed in a state in which a program such as an advertisement printing program, an advertisement copying program or the like is stored in a ROM. However, the present invention is not limited to this, and the image processing apparatus may be accessed in a state in which the program is not stored in the ROM. In this case, a control program or the like transferred independent of the image processing apparatus may be written in a writable storage device provided in the image processing apparatus in response to an operation by a user or the like. The transfer of the advertisement printing program, the advertisement copying program or the like can be carried out by recording it on a removable recording medium or by communication via a network. The recording medium may be in any form as long as it can store a program and is readable by the apparatus, such as a CD-ROM (Compact Disc Read-Only Memory), a memory card, etc. A function obtained by installing or downloading the program may be one which realizes the function in cooperation with an OS (Operating System) or the like in the apparatus.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of embodiments described herein may be made without departing from the spirit of the inventions. The accompanying claims and their equivalents are intended to cover such forms or modifications as would fall within the scope and spirit of the invention.

What is claimed is:

1. An image processing system, comprising:
a server configured to transmit, over a network, print data including a first identification of the print data;
an image processing apparatus configured to:
receive the print data;
obtain the first identification of the print data from the print data;
generate code symbol data indicating the first identification of the print data and a second identification of the image processing apparatus; and
print, on a sheet, an image corresponding to the print data together with a first code symbol corresponding to the code symbol data.

2. The image processing system according to claim 1, wherein
the print data transmitted by the server further includes a first value indicating a maximum number of times the image is allowed to be copied, and
the code symbol data includes the first value and a second value indicating a number of times the image has been copied.

3. The image processing system according to claim 2, wherein
the image processing apparatus is further configured to, during a copy operation:
obtain the first value and the second value by scanning the image and the first code symbol printed on the sheet;
generate second code symbol data indicating the first identification of the print data, the second identification of the image processing apparatus, the first value, and a value incremented from the second value; and
print the scanned image together with a second code symbol corresponding to the second code symbol data.

4. The image processing system according to claim 3, wherein
the image processing apparatus is further configured to, during the copy operation:
compare the obtained first and second values; and
generate the second code symbol data, upon determining that the value incremented from the second value is equal to or less than the first value.

5. The image processing system according to claim 4, wherein
the image processing apparatus is further configured to, during the copy operation, prohibit copying of the image when determining that the value incremented from second value is greater than the first value.

6. The image processing system according to claim 2, wherein the image processing apparatus prints the scanned image and the second code symbol without the first code symbol.

7. The image processing system according to claim 6, wherein the image processing apparatus prints wherein the second code symbol at a relative position to the image same as a position at which the first code symbol is printed relative to the image.

8. The image processing system according to claim 2, wherein the image processing apparatus prints the scanned image and the second code symbol together with the first code symbol.

9. An image processing apparatus, comprising:
a printer device;
a communication interface configured to receive print data transmitted over a network; and
a controller configured to:
obtain a first identification of the print data from the print data;
generate code symbol data indicating the first identification of the print data and a second identification of the image processing apparatus; and
control the printer device to print, on a sheet, an image corresponding to the print data together with a first code symbol corresponding to the code symbol data.

10. The image processing apparatus according to claim 9, further comprising a scanner device, wherein
the code symbol data includes a first value indicating a number of times the image has been copied, and
the controller is further configured to, during a copy operation:
obtain the first value when the scanner device scans the printed image and first code symbol on the sheet;
generate second code symbol data indicating the first identification of the print data, the second identification of the image processing apparatus, and a value incremented from the first value; and
control the printer device to print the scanned image together with a second code symbol corresponding to the second code symbol data.

11. The image processing apparatus according to claim 10, wherein
the code symbol data further includes a second value indicating a maximum number of times the image is allowed to be copied, and
the controller is further configured to, during the copy operation:
obtain the second value when the scanner device scans the image and code symbol printed on the sheet;
compare the obtained first and second values; and
generate the second code symbol data, upon determining that the value incremented from the first value is equal to or less than the second value.

12. The image processing apparatus according to claim 11, wherein
the controller is further configured to, during the copy operation, prohibit copying of the image when determining that the value incremented from first value is greater than the second value.

13. The image processing apparatus according to claim 10, wherein the controller is configured to control the printer device to print the scanned image and the second code symbol without the first code symbol.

14. The image processing apparatus according to claim 13, wherein the second code symbol is printed at a relative position to the image same as a position at which the first code symbol is printed relative to the image.

15. The image processing apparatus according to claim 10, wherein the controller is configured to control the printer device to print the scanned image and the second code symbol together with the first code symbol.

16. An image processing method comprising:
receiving print data transmitted over a network;
obtaining a first identification of the print data from the print data;
generating code symbol data indicating the first identification of the print data and a second identification of a first image processing apparatus; and
printing, using the first image processing apparatus, an image corresponding to the print data together with a first code symbol corresponding to the code symbol data on a sheet.

17. The image processing method according to claim 16, wherein the code symbol data includes a first value indicating a number of times the image has been copied, and the method further comprises:
carrying out a copy operation including:
scanning the image and the first code symbol printed on the sheet;
obtaining the first value from the scanned first code symbol;
generating second code symbol data indicating the first identification of the print data, a third identification of a second image processing apparatus carrying out the copy operation, and a value incremented from the first value; and
printing the scanned image together with a second code symbol corresponding to the second code symbol data.

18. The image processing method according to claim 17, wherein the code symbol data further includes a second value indicating a maximum number of times the image is allowed to be copied, and the copy operation further includes:
obtaining the second value from the scanned first code symbol; and
comparing the obtained first and second values, wherein the second code symbol data is generated upon determining that the value incremented from the first value is equal to or less than the second value.

19. The image processing method according to claim 18, wherein the copy operation is terminated when the value incremented from first value is greater than the second value.

20. The image processing method according to claim 17, wherein the first image processing apparatus is different from the second image processing apparatus.
